(19) United States
(12) Patent Application Publication
(10) Pub. No.: US 2024/0286213 A1
(43) Pub. Date: Aug. 29, 2024

(54) SYSTEMS AND METHODS FOR ELECTROCHEMICAL MACHINING

(71) Applicant: Illinois Tool Works Inc., Glenview, IL (US)

(72) Inventors: Evans Mogire, Loughborough (GB); Matt Callahan, Deerfield, IL (US); Jill Dreschler, Round Lake, IL (US); Calvin Nelson, Grayslake, IL (US); Zach Swedo, Lake Bluff, IL (US); Chris Sensmeier, Chicago, IL (US); Roland Schaefer, Gurnee, IL (US); Andrew Nocom, Lake Zurich, IL (US); Michael E. Keeble, Libertyville, IL (US)

(21) Appl. No.: 18/404,615

(22) Filed: Jan. 4, 2024

Related U.S. Application Data
(60) Provisional application No. 63/437,433, filed on Jan. 6, 2023.

(51) Int. Cl. B23H 3/02; B23H 11/00

(52) U.S. Cl. CPC B23H 3/02; B23H 11/00

(57) ABSTRACT

Example electrochemical machining systems and methods for machining a surface of a sample. In particular, the system includes a nozzle configured to dispense a jet of an electrolyte solution towards the surface of the sample. A position or orientation of the nozzle can be controlled to direct the jet of the electrolyte solution from the nozzle towards an area of the surface of the sample (e.g., an area for electrochemical etching or other surface treatment). The electrochemical machining is performed by application of a charge to the nozzle and apply a charge to the sample (e.g., grounding or other charge return path), such that the nozzle and the sample define first and second electrodes of an electrolytic cell, electrically connected by the jet of electrolyte solution.

### CROSS REFERENCE TO RELATED APPLICATIONS

This application is a Non-Provisional Patent Application of U.S. Provisional Patent Application No. 63/437,433 entitled “Systems And Methods For Electrochemical Machining” filed Jan. 6, 2023, which is herein incorporated by reference in its entirety.

### BACKGROUND

Electrochemical machining operations are performed on specimens for numerous purposes and across a vast array of sectors and industries. In some applications, electrochemical machining is conducted by application of a fluid via a nozzle. However, performing dynamic electrochemical machining processes are difficult and time consuming, and may be difficult to ensure consistent results. Therefore, systems and methods that provide a variety of features while maintaining consistent results are desirable.

### SUMMARY

Systems and methods are disclosed for dynamic electrochemical machining, substantially as illustrated by and described in connection with at least one of the figures, as set forth more completely in the claims.

### BRIEF DESCRIPTION OF THE DRAWINGS

FIG. 1 illustrates an example electrochemical machining system, in accordance with aspects of this disclosure.

FIG. 1A illustrates another view of the example electrochemical machining system of FIG. 1.

FIG. 2 illustrates another example electrochemical machining system, in accordance with aspects of this disclosure.

FIG. 3 illustrates another implementation of the example electrochemical machining system of FIG. 2.

FIG. 4 illustrates another example electrochemical machining system, in accordance with aspects of this disclosure.

FIG. 5 illustrates a detailed view of an example reservoir in accordance with aspects of this disclosure.

FIG. 6 an example fixture to support multiple samples for electrochemical machining, in accordance with aspects of this disclosure.

FIG. 7, illustrates another example electrochemical machining system that includes a filtering system, in accordance with aspects of this disclosure.

The figures are not necessarily to scale. Wherever appropriate, similar or identical reference numerals are used to refer to similar or identical components.

### DETAILED DESCRIPTION

Disclosed are electrochemical machining systems and methods for machining a surface of a sample. In particular, the system includes a nozzle configured to dispense a jet of an electrolyte solution towards the surface of the sample. A position or orientation of the nozzle can be controlled to direct the jet of the electrolyte solution from the nozzle towards an area of the surface of the sample (e.g., an area for electrochemical etching or other surface treatment). The electrochemical machining is performed by application of a charge to the nozzle and apply a charge to the sample (e.g., grounding or other charge return path), such that the nozzle and the sample define first and second electrodes of an electrolytic cell, electrically connected by the jet of electrolyte solution.

The system controls an amount and/or location of the electrochemical machining by monitoring system parameters (e.g., conditions of the fluid, the sample, electrical characteristics such as current/voltage, etc.) and adjusting one or more system outputs accordingly. For example, a controller or control circuitry (e.g., an integrated or linked computer system) can receive the monitored system parameters (e.g., from a sensor, output values, etc.) and control an adjustment to one or more system components. This can include adjusting one or more of a volumetric rate of the electrolytic jet, a pressure of the flow, a speed of the nozzle, the distance between the nozzle and sample, the electrical properties of the electrolytic solution, a source or type of fluid employed, as a list of non-limiting examples.

Some example systems employ multiple reservoirs or tanks to store multiple fluids, which can be applied by one or more nozzles to treat a sample, in a single or multiple cycles of a selected treatment program. In some examples, a particular program and/or cycle can be input by a user (e.g., via a user interface), selected by a user via a list of stored programs and/or cycles, and/or automatically identified and executed by the control circuitry. For instance, a sample, fluid type, and/or system may be automatically identified (e.g., by identification of an indicator, such as a code and/or innate property of the sample), and the control circuitry can automatically select an appropriate program (e.g., from the list). The program and/or cycle can include control location and character of the applied jet of electrolytic solution, such that a desired area of the sample is processed in accordance with a predetermined set of output parameters (e.g., amount of time, location, and/or amount of processing).

These are improvements over conventional systems, which are limited to a single nozzle processing a single specimen in accordance with a strict point-to-point application. This requires a user to reconfigure the sample and/or system for any processing beyond the simplest of cycles. The result is additional time and resources devoted, not to testing, but to separating and arranging specimens.

The disclosed sample holding fixtures and systems enable the operator to move an entire sample holder tray and mount it directly onto the electrochemical machining system without unloading individual specimens. This significantly reduces the amount of work required to process multiple specimens and reduces the chance for accidental scratches and/or other damage to the specimens.

Advantageously, employing the disclosed systems and methods allows for increased throughput as the system can process multiple samples without requiring a user to configure the system differently and individually for each cycle or program. By simplified and/or automatic recognition of the sample and/or desired cycle/program, the configuration time is accelerated and dynamic, such that different processing steps can be performed during a single program run. This includes the processing of multiple samples in a single program. Moreover, processing the sample with multiple nozzles results in significant reduction in the cycle time (e.g., such as about a 50% reduction for two nozzles, about 66% reduction for three nozzles, etc.) thus enables a user to complete the process faster than existing methods.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments” does not require that all disclosed embodiments include the discussed feature, advantage, or mode of operation.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the terms “e.g.” and “for example” set off lists of one or more non-limiting examples, instances, or illustrations.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

In disclosed examples, an electrochemical machining system for machining a surface of a sample. The system includes a nozzle configured to dispense a jet of an electrolyte solution towards the surface of the sample; and control circuitry to control an electrochemical machining process. The control circuitry is configured to receive an input providing a program for the sample; direct the jet of the electrolyte solution from the nozzle towards a portion of the surface of the sample based on the program; and apply a charge to the nozzle and apply a charge to the sample such that the nozzle and the sample define first and second electrodes of an electrolytic cell based on the program.

In some examples, the system includes an interface to receive the input from a user or a code. In examples, the control circuitry is further configured to automatically select a program for the sample based on the input or the code.

In some examples, the control circuitry is further configured to monitor one or more system parameters of the surface; and adjust one or more of a volumetric rate, a pressure, or a speed, of the electrolyte solution application in response to the one or more system parameters based on the program. In examples, the one or more system parameters of the surface includes a voltage or a current. In examples, the control circuitry is further configured to measure the voltage or the current levels; compare the measured voltage or current to a list of threshold voltage or current values; and adjust the voltage or current level when the measured voltage or current a threshold voltage or current value.

In some examples, the device is configured to apply the jet of electrolyte solution to multiple samples in a single cycle. In examples, the control circuitry is further configured to receive first and second electrochemical machining programs from the input; apply the jet of electrolyte solution to a first area of the sample at a first volumetric rate, a first pressure, or a first speed during a first electrochemical machining program; and apply the jet of electrolyte solution to a second area of the sample at a second volumetric rate, a second pressure, or a second speed during a second electrochemical machining program.

In some examples, the system includes a sensor to monitor one or more system parameters. In examples, the sensor is a fluid sensor to monitor one or more of a conductivity, a refractive index, a viscosity, flow rate, or a charge of the electrolyte solution. In examples, the sensor is an optical system or a laser system configured to image or scan the sample. In examples, the sensor is an optical system or a laser system configured to image or scan an indicator representing the code or other information of the sample.

In some examples, the system includes an optical system or a laser system configured to present a reference image on the sample or a stage on which the sample is placed, to align the sample in a desired position on the stage relative to the nozzle.

In some examples, the system includes a valve configured to receive an external input of airflow to flush the electrolyte solution from the nozzle.

In some disclosed examples, an electrochemical machining system for machining a surface of one or more samples. The system includes one or more nozzles configured to dispense one or more jets of one or more electrolyte solutions towards the surface of the one or more samples; and control circuitry to control an electrochemical machining process. The control circuitry is configured to direct the one or more jets of the one or more electrolyte solutions from a first nozzle of the one or more nozzles towards a first portion of the surface of the one or more samples; direct the one or more jets of the one or more electrolyte solutions from a second nozzle of the one or more nozzles towards a second portion of the surface of the one or more samples; and apply a charge to the one or more nozzles and apply a charge to the one or more samples such that the nozzles and the samples define first and second electrodes of an electrolytic cell.

In some examples, the control circuitry is further configured to control the first nozzle independently of the second nozzle.

In some examples, the first nozzle is configured to apply the one or more jets as a first jet of a first electrolyte solution to the one or more samples, and the second nozzle is configured to apply the one or more jets as a second jet of a second electrolyte solution to the one or more samples. In examples, the first nozzle is configured to apply the first jet of the first electrolyte solution to the first portion of the surface of the sample at a first volumetric rate, a first pressure, or a first speed, and the second nozzle is configured to apply the jet of the second electrolyte solution to the second portion of the surface of the sample at a second volumetric rate, a second pressure, or a second speed. In examples, the first volumetric rate, the first pressure, or the first speed correspond to a first electrochemical machining program, and wherein the second volumetric rate, the second pressure, or the second speed correspond to a second electrochemical machining program.

In some examples, the control circuitry is configured to monitor one or more system parameters; and adjust one or more of the first or second volumetric rate, the first or second pressure, or the first or second speed, of the first or second electrolyte solution application in response to the one or more system parameters.

In some examples, the system includes a first reservoir containing the first electrolyte solution and a second reservoir containing the second electrolyte solution.

In some examples, the first and second portions overlap.

In some examples, the first and second portions do not overlap.

In some examples, the first and second nozzles operate simultaneously.

In some examples, the system includes an interface to receive the input from a user or a code.

In some examples, the control circuitry is further configured to automatically select a program or an electrochemical machining program for the one or more samples based on the input or the code.

In some examples, the system includes one or more valves configured to receive an external input of airflow to flush the one or more electrolyte solutions from the first or second nozzle.

In some disclosed examples, electrochemical machining system for machining a surface of one or more samples. The system includes one or more reservoirs containing one or more electrolyte solutions; one or more nozzles configured to dispense the one or more electrolyte solutions in one or more jets towards the surface of the one or more samples; and control circuitry to control one or more electrochemical machining processes. The control circuitry is configured to direct the one or more jets of the one or more electrolyte solutions from a first reservoir of the one or more reservoirs towards a first portion of a surface of a first sample of the one or more samples; and direct the one or more jets of the one or more electrolyte solutions from a second reservoir of the one or more reservoirs towards a first portion of a surface of a second sample of the one or more samples; and apply a charge to the one or more nozzles and apply a charge to the one or more samples such that the nozzles and the samples define first and second electrodes of an electrolytic cell.

In some examples, the one or more electrolyte solutions comprises a first electrolyte solution contained in the first reservoir and a second electrolyte solution contained in the second reservoir.

In some examples, one of the first or second reservoir includes multiple chambers to hold one or more of a first electrolyte solution, a second electrolyte solution, or other fluids.

In some examples, the system further includes a water reservoir to recirculate rinse water during the electrochemical machining process.

In some examples, the system further includes a valve configured to receive an external input of airflow to flush the electrolyte solution from the nozzle.

In some examples, the system further includes an interface to receive the input from a user or a code. In examples, the control circuitry is further configured to receive an input providing a size or a processing cycle for the one or more samples. In examples, the control circuitry is further configured to automatically select a program or an electrochemical machining program for the one or more samples based on the input or the code. In examples, the control circuitry is further configured to receive selection of a sample type or an electrochemical machining program for the one or more samples and to automatically select the first or second electrolyte based on the selected sample type or electrochemical machining program.

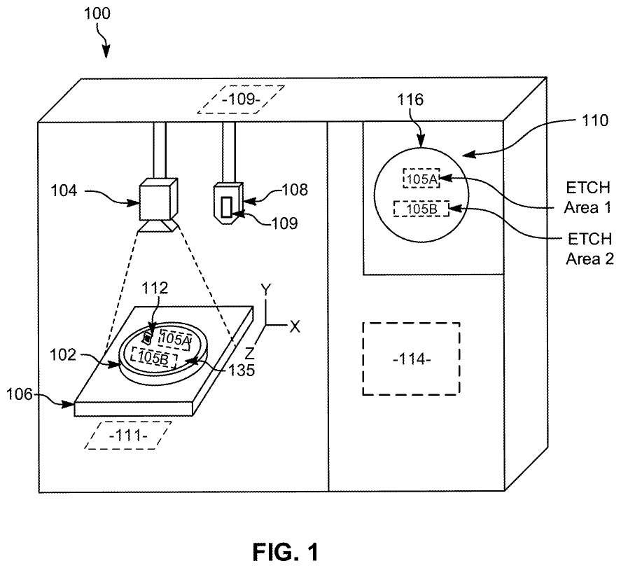

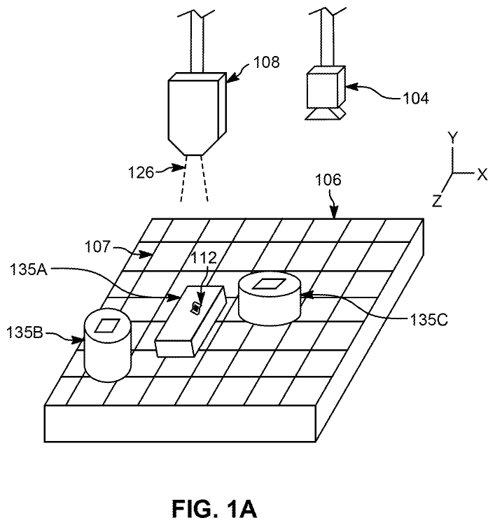

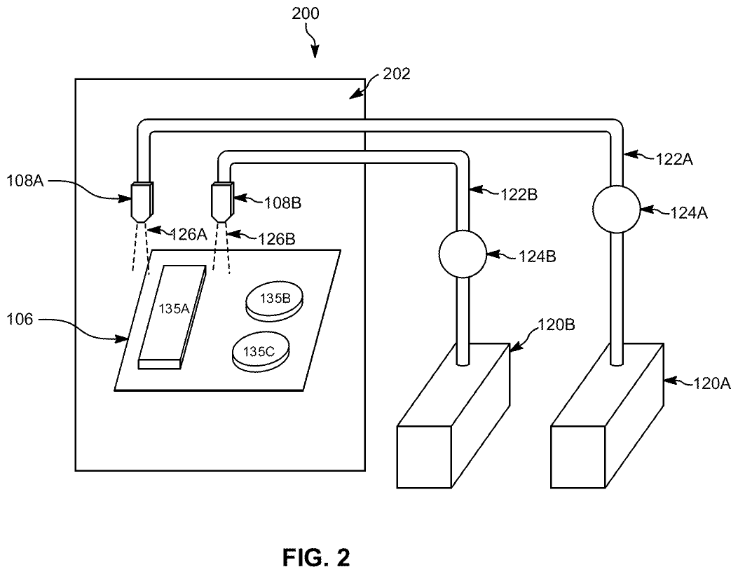

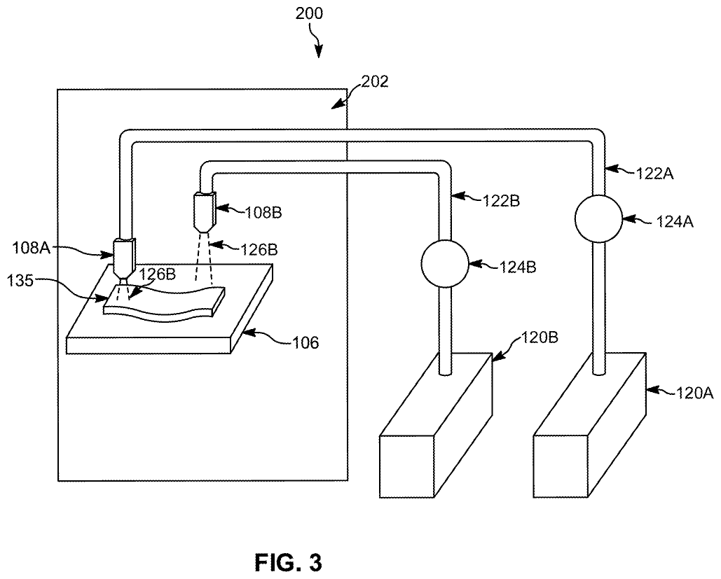

FIG. 1 illustrates an electrochemical machining system 100 for machining a surface of a sample or workpiece 135. In particular, the system 100 enables a user to process one or more samples 135, including multiple processes on multiple samples, in a single sample processing cycle (e.g., according to one or more processing programs). In some examples, one or more nozzles 108 are connected to one or more tanks or reservoirs 120 via one or more conduits 122, with control of the flow of fluids from the reservoir controlled via one or more pump (e.g., see example FIGS. 2 and 3). In example, a controller or processor 114 connected to the system 100 controls movement of the nozzle (e.g., by control of one or more motors, actuators, etc.) in accordance with a selected program and/or cycle.

As shown in FIG. 1, there are multiple ways of implementing such features, such as by employing an imaging device 104 (e.g., a camera, vision capture system). One or more samples 135 (e.g., within a fixture 102) are arranged onto a stage 106, with a surface of the stage 106 having a number of coordinates (e.g., on an X-Y- or Z-axis). In some examples, the coordinates correspond to a start point, an endpoint, and/or one or more intermediate points for each sample and/or each sample processing cycle. A program can be selected (e.g., by a user via a user interface 110, and/or identified automatically via one or more inputs and/or triggers) to be run on each sample, and initiated through similar means. Once selected or identified, the system 100 performs the given program across the areas of the sample corresponding to the selected program. In some examples, the system is enabled to notify the user (e.g., via an alert, display on a user interface, etc.) corresponding to one or more milestones throughout the program, such as a particular treatment of a particular sample, upon completion of a cycle or portion of a cycle of the selected program, and/or completion of the program itself.

In an example, a sample 135 is loaded into a fixture 102 (e.g., a sample holder) then loads the fixture into the system 100, such as on the stage 106. The fixture 102, sample(s) 135, and/or the stage 106 contains one or more locating features (e.g., text, graphics, a shape or geometry, etc.), to ensure the fixture is loaded into the system 100 in a predefined location, orientation and/or Z-axis position, relative to the stage 106, the imaging device 104, a nozzle 108, and/or some other system reference point.

The system 100 has the capability to scan a surface area (e.g., the X- and Y-axes) of the sample to be treated in order to optimize the treatment process and avoid overlap of electrolyte application to the sample. This includes the ability of the system 100 to process larger areas on a given sample as well as processing larger samples within a shorter time. In an example, the system 100 can scan the sample surface area (e.g., by use of the imaging device 104 and/or other sensor, such as laser raster scanning), and/or a user can input coordinates of one or both of the X coordinates (e.g., endpoints of the sample from left-to-right) and Y coordinates (e.g., endpoints of the sample from front-to-back). The control system 114 is configured to optimize the processing cycle to process the entire area in a single run. This includes determining the location of the nozzle 108 relative to the sample (e.g., the X-Y- or Z-axes), the volume of electrolyte, the rate of electrolyte application, and/or type of electrolyte being delivered at different points along the sample surface area.

In some examples, the surface of the sample may be non-uniform. For instance, the height or Z-distance from the nozzle 108 and/or stage 106 may vary across the area to be treated. However, ensuring the distance between the nozzle and the surface of the sample is important to consistent and quality treatment of the sample. Thus, the system 100 is configured to map the surface to recognize when the sample is not level. This can be accomplished by probing the surface with the nozzle 108, such as by making contact with the surface at different points along the sample, and correlating the height measurements to their corresponding X-Y coordinates (e.g., either known, determined by one or more sensors, and/or input by the user), thereby creating a map of the surface plane. Based on the height measurements, the system 100 controls the nozzle 108 to adjust its position in the Z-axis relative to the sample as the nozzle traverses the sample surface during the treatment process.

In some examples, a user command (e.g., via the UI 110) is provided to indicate the type of fixture being used, and the system 100 is able to identify a location of the sample (e.g., by accessing a list stored in a connected memory device). The particular program to be run on each sample(s) begins in response to an input and/or trigger (e.g., a user selection, in response to a timer, completion of a predetermined condition, etc.). The system 100 then executes the program across each sample and/or identified areas, and provides a notification to the user when the cycle(s) are complete.

In some examples, an indicator 112 (e.g., a code, a tag, a radio frequency device, etc.) on the fixture and/or sample is captured by the system 100 (e.g., via one or more sensors, image capture device 104, etc.), by which the system 100 is able to automatically identify the fixture and/or the sample without additional user input. In some examples, the system 100 scans the indicator to identify the type of fixture and/or sample loaded on the stage 106, and the system 100 identifies the sample 135 by accessing a list of sample types associated with various indicators (e.g., in a memory device). Based on the identification, and the particular program to be run on each sample, the system initiates the machining cycle(s).

In some examples, the image capture device 104 can provide a visual indication to a user corresponding to a characteristic 105 of the sample 135, progress of the machining program, or other feature associated with the system. For instance, the image capture device 104 could be a laser scanner and/or a light beam transmitter to illuminate a starting point of the etching cycle and/or follow the movement of the nozzle and/or electrolyte solution during the cycle. This makes it easier for the user to position the nozzle at the starting and ending points of the etching cycle, and/or regulate the machining path taken during the program.

In an example, a reference indicator is projected onto the sample and/or the stage to indicate proper placement of the sample 135 on the stage 106. For instance, optical and/or laser light can be projected (e.g., from projection device 109 collocated with nozzle 108) as a single point or dot, as a border corresponding to the area of the sample 135 and/or treatment area, such that the user and/or robotic system may place the sample 135 in the desired position on the stage 106. Once the sample 135 is positioned, another sensor (e.g., imaging device 104) can verify the placement on the stage 106.

Although some examples describe employing a sensor, such as a single, image capture device/camera to collect information, some examples employ a variety of sensors in a variety of numbers. For instance, one or more sensors may monitor environmental conditions (e.g., temperature, humidity, chemical content, etc.) and/or system parameters (e.g., voltage, current, power, etc.). The sensors may be arranged within the system apparatus and/or external to the system. Further, the sensors may be integrated with the system and/or in linked via a separate, remote system.

In some examples, the user interface 110 is interactive, operable to receive inputs and to present information, such as configurable soft keys, information regarding the sample and/or program, as well as images captured by the system 100. For instance, the imaging device 104 is operable to capture an image 116 of the samples 135 and to display the image 116 on the user interface 110. Based on the captured image data, the user and/or the system 100 can calibrate the system and/or the imaging device 104, such as by setting a reference position (e.g., an X-, Y-, or Z-axis) on the sample 135 and/or the stage 106, directly via the digital representation (e.g., 2D, 3D) of the sample in image 116. In some examples, a user can select points along the sample 135 and/or the stage 106 via the user interface 110 by navigating the scanned image corresponding to a nozzle starting position and subsequent positions, irrespective of how the sample was loaded/arranged on the stage, or in the absence of a stage. Additionally or alternatively, the user can select a program via the user interface 110 (and/or the system can automatically select the program) for each sample, as well as initiate the program and/or cycle.

As shown in FIG. 1, sample 135 is processed with a first etch area 105A and a second etch area 105B. In other words, the system 100 can control the nozzle 108 and/or stage 106 to move relative to the other, in order to treat a different sample and/or area of a sample in accordance with the program and/or cycle.

In some examples, the system components (e.g., imaging device 104, nozzle 108 and/or nozzle movement system 109, user interface 110, stage 106 and/or stage movement device 111, etc.) communicate with the controller or control circuitry 114 via a wired and/or wireless connection. In some examples, the controller 114 is operable to control one or more parameters of the program and/or cycle in response to an input from a user (e.g., via user interface 110). For example, the controller 114 can adjust a speed of the program execution, a position of the one or more components, a flow rate of the fluid, imaging of the sample, etc.

The controller 114 is further operable to cause the user interface 110 to display information regarding execution of the program or cycle, an alert, and/or the image 116. In some examples, the controller 114 is connected to a remote device (e.g., a tablet, a smartphone, a network, remote computer, etc.), and information can be transmitted (via wires or wirelessly) to such a device.

Although some example systems are shown employing a single nozzle, one or more of the disclosed systems and/or methods can consist of two or more nozzles. For multiple nozzles, during a cycle or program, a user can select a number of nozzles to employ, on which samples, or the system can determine an appropriate and/or optimal processing step(s) for each nozzle. The system will then control each nozzle independently to conduct the cycle(s). For instance, one or more actuators, motors, drive or gear mechanisms can control movement of the nozzle(s) to execute the selected cycle or program.

FIG. 1A illustrates a stage 106 with multiple samples 135A, 135B, 135C loaded freely thereon. For example, a grid and/or other recognizable pattern 107 can be overlaid on a surface of the stage 106. The grid/pattern 107 can have one or more reference features to identify a location of a sample on the stage 106, as well as a relative location of the various samples. The imaging device 104 can capture location data and information relating to identification of each sample. Location and identification information is used by the controller 114 to control processing of the samples.

FIG. 2 illustrates another example electrochemical machining system 200 employing two or more nozzles 108A and 108B operating within an etching chamber 202. Each nozzle is connected to a tank or reservoir 120A or 120B, respectively, via one or more conduits 122A, 122B. In some examples, a pump 124A, 124B controls flow of one or more fluids (e.g., electrolyte solutions) from the tanks 120A, 120B, controlled via the system 200 (e.g., via a controller and/or processor) in accordance with a selected program and/or cycle.

In some examples, pump 124A and pump 124B control flow of one or more fluids from a single tank (e.g., tank 120A or tank 120B) to one or both nozzles 108A and 108B. In examples where the single tank includes multiple chambers, multiple fluids may be drawn from different chambers. In some examples, the pump 124A controls fluid flow from tank 120A, and pump 124A controls fluid flow from tank 120B separately and independently from pump 124A, as shown in FIG. 2.

In some examples, both nozzles 108A and 108B are in operation simultaneously, with nozzle 108A dispensing a first fluid 126A under pressure onto sample 135A, and nozzle 108B dispensing a second fluid 126B under pressure onto samples 135B and/or 135C. In some examples, each nozzle dispenses their respective fluids to the one or more samples during a program, which may apply each fluid at different times during the program, on different areas of one or more of the samples, and/or in accordance with one or more application parameters (e.g., volumetric rate, a pressure, a speed, a duration of time, etc.).

Employing multiple reservoirs has the benefits of increasing throughput of the system, samples can be processed with different fluids (e.g., electrolytes) without the need to change reservoirs and/or systems. Thus, a program that employs multiple/different fluids can be loaded on the system and executed as disclosed herein. Further, users are able to place the machine in a location without a rinse water connection, as water can be loaded into one of the reservoirs for use during a rinse cycle within the program.

FIG. 3 illustrates another implementation of the example system 200 employing multiple nozzles. As shown, a single sample 135 is subject to treatment from first and second fluids 126A and 126B. Such a treatment can apply the fluids simultaneously, in series, and/or as an alternating cycle.

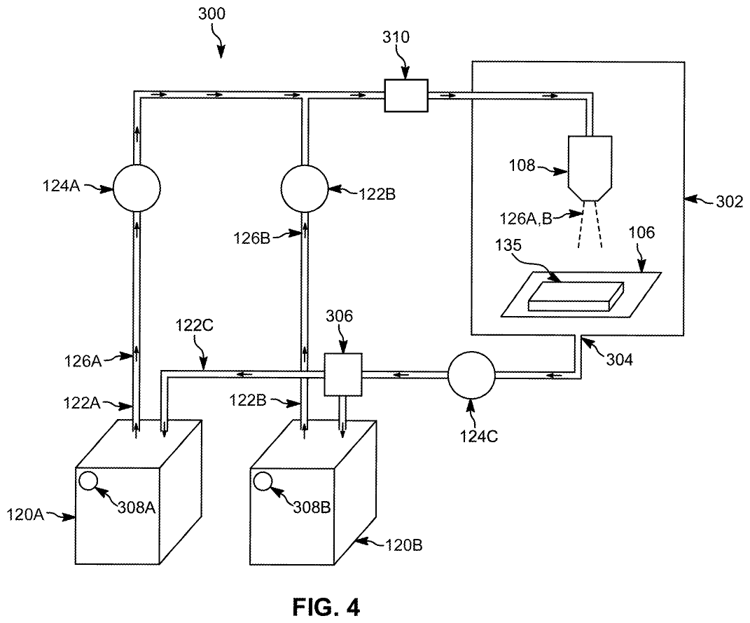

FIG. 4 illustrates another system 300 employing multiple reservoirs 120A and 120B, similar to system 200. However, in the example of FIG. 4, a single nozzle 108 capable of applying the first and or second fluids 126A and 126B is within an enclosure 302, to treat a sample 135. The system 300 employs multiple reservoirs configured to operate independently of the other. The reservoirs may consist of one or more of an electrolyte, water, and/or other suitable fluids. In some examples, a third reservoir, pump, and/or nozzle may be included to provide rinse water, such as in a closed system (without being incorporated into the plumbing system).

In some examples, one or more connectors or valves 310 is arranged along one or more of the conduits leading to the nozzle 108. The valve is configured to introduce a fluid and/or gas (e.g., compressed air, environmental air, inert gases, etc.) into the conduits to flush fluid from and/or through the conduits, thereby clearing the nozzle 108 of fluid(s), as well as cleaning off the sample 135 and/or stage 106. For instance, compressed air can be introduced at the valve 310 (e.g., via a hose, additional conduit, etc.) during equipment calibration, process setup, between application of different fluids, and/or following a completed program or cycle. In some examples, operation of an air compressor is controlled by the control circuitry 114 to coordinate with operation of other system components.

In an example, the system 300 controls pump 124A to pump fluid 126A to the nozzle 108 to treat the sample 105. During this cycle, the fluid 126A flows into drain 304 and is pumped via pump 124C to valve 306. The valve 306 is controlled to selectively channel fluid to the appropriate reservoir (e.g., reservoir 120A) to avoid cross-contamination between fluids. Employing multiple reservoirs in a single system, capable of channeling different fluids to the corresponding reservoir, provides a degree of flexibility not available in treatment systems containing only one pump and/or reservoir. In particular, treating a sample with different electrolytes in a system with one pump and/or reservoir would necessitate removal and replacement of the reservoir, and/or change of the fluid before beginning the next part of the cycle.

As shown, one or both of reservoirs 120A and 120B can include one or more sensors 308A and 308B, respectively. The sensors are configured to monitor one or more characteristics of the fluid (e.g., before, during, and/or after a cycle or program) and provide data corresponding to the characteristics to a controller. The characteristics can include one or more of conductivity, a refractive index, a viscosity, flow rate, or a charge of the fluid, as a list of non-limiting examples. This data allows the system to determine useful information about the quality, or “health”, of the fluid (e.g., electrolyte). This may result in a comparison of the one or more fluid characteristics to a list, which associates fluid characteristics with sample types and/or treatment outcomes. This would enable the machine to quantitatively determine the quality of a fluid, the remaining useful life of the fluid, and/or whether it is still suitable for use as a given treatment.

Advantageously, employing sensors and determining a quality of the fluid allows the system to provide more consistent treatment results. In particular, when an electrolyte fluid is outside a threshold range of quality values, damage to the samples from poor etching and/or polishing can be avoided, as well as time for rework (of a damaged sample) and/or extra time spent in the process (to compensate for use of a low quality fluid). This system is operable to provide an alert to a user that the fluid should be changed, prior to running a program with a low quality fluid. In some examples, the sensors are further configured to measure other system parameters, such as a volume of fluid within the reservoir, and a temperature of the fluid or the system, as a list of non-limiting examples.

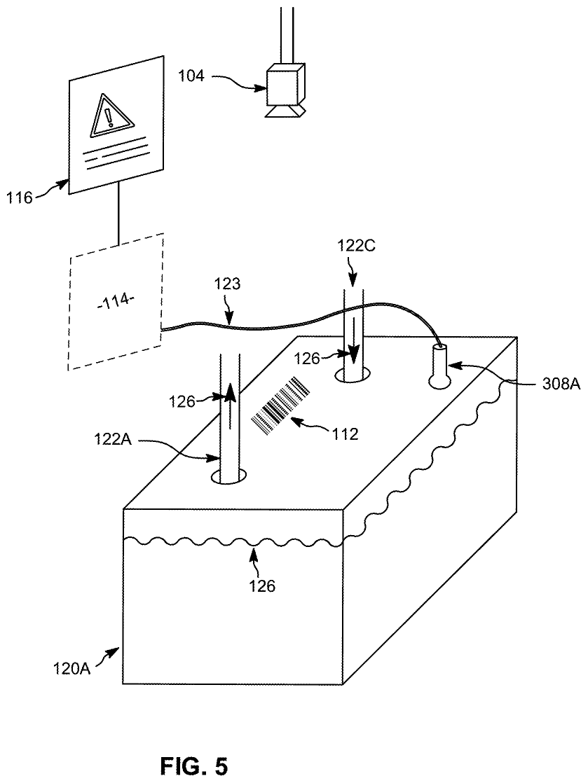

FIG. 5 illustrates a detailed view of the example reservoir 120A of FIG. 4. As shown, the reservoir 120A holds an amount of fluid 126, which can be pumped out through conduit 122A, and channeled back into the reservoir via conduit 122C. A sensor 308A is incorporated with the reservoir 120A and configured to measure one or more properties of the fluid. The sensor 308A is connected to the controller 114 via wired and/or wireless cabling 123. As shown, information regarding the quality of the fluid 126 can be presented in the user interface 116.

In some examples, the reservoir 120A may be labeled with an indicator, radio frequency identification (RFID) tag, and/or code 112 readable by one or more sensors (e.g., image capture device 104, radio frequency reader, near filed communication (NFC) reader, etc.) of the system to automatically provide data to the system controller 114 regarding the type of reservoir, type of fluid within the reservoir, and/or other information associated with the reservoir or fluid. The data enables the controller to track operation of the one or more pumps, indicating which fluid is in use and to automatically select the appropriate or desired fluid for a given machining cycle.

In some examples, a user may input information related to the reservoir and/or fluid via the user interface 110. This allows for changes to the system, such as a manual override, and/or for inputting information in a system without a corresponding sensor and/or when no indicator is present on the reservoir. The system may include a sensor 128 (e.g., a contact sensor, a weight sensor, an optical sensor, a laser sensor, etc.) to detect the presence and/or absence of a reservoir. Having determined the presence of a reservoir (e.g., based on data from the sensor 128), the user interface 110 can prompt the user to input information regarding the type of electrolyte contained in the reservoir, which is then logged into memory of the system controller 114.

Although the example of FIG. 5 illustrates a single reservoir 120A, the concepts for identifying the reservoir and/or fluid, and/or monitoring fluid characteristics, are equally applicable to systems employing one or multiple reservoirs and/or one or more nozzles.

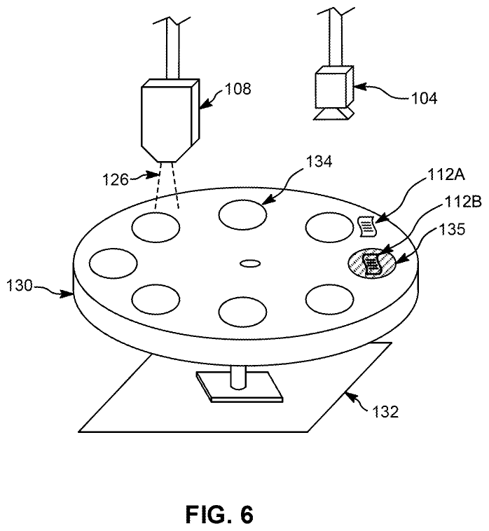

FIG. 6 illustrates an example fixture 130 configured to support multiple samples 135. For instance, the fixture 130 can include multiple holes 134 to receive each sample 135. As shown, one or more indicators 112A can be arranged on the fixture 130 and/or one or more indicators 112B can be arranged on the samples 135. These indicators can be captured by the image detection device 104, the captured data transmitted to the controller 114, where the data can be used to determine an appropriate program and/or cycle for the one or more samples 135, as disclosed herein. As shown, the fixture 130 can be mounted on a platform 132, which may facilitate movement of the fixture 130 (e.g., rotational movement) relative to the nozzle 108 and/or the imagining device 104.

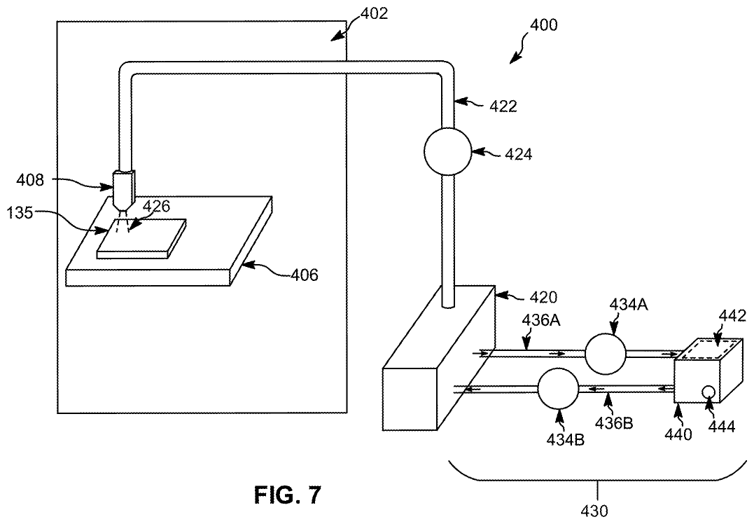

FIG. 7 illustrates another system 400 employing a reservoir 420, similar to system 100, shown with a single nozzle 408 capable of applying fluids 426 within an enclosure 402, to treat a sample 135. A conduit 422 receives the fluid 426 from the reservoir 420, aided by a pump or valve 424. Although the example system 400 employs a single reservoir, in some examples multiple reservoirs can be used, as disclosed herein.

As provided in the example of FIG. 7, a filtering system 430 to filter the electrolyte fluid can be connected to the reservoir 420 via one or more conduits 436A and 436B. One or more pumps or valves 434A and 434B can draw fluid from the reservoir 420 into the filter tank 440 and through filter 442, and/or force fluid back to the reservoir in preparation for another sample treatment operation.

A filtering operation implemented through the filtering system 430 and/or the reservoirs may include forcing one or more of an electrolyte, water, and/or other suitable fluids (e.g., contained in the reservoir 420, the conduits 422, the nozzle 408, the valve 424, etc.) through the conduits 436A and 436B, valves 434A and 434B, and/or the filter 442. Such a rinse can be implemented between filtering operations employing first and second reservoirs and/or first and second fluids (e.g., first and section electrolytes). Thus, the filtering operation removes impurities from the fluid (e.g., electrolyte) to provide a more consistent application of the electrolyte during treatment.

The filter 442 may include a single filter and/or multiple filters, one or more of which may be removable from the tank 440 for cleaning and/or replacement. Although filter 442 is illustrated as being arranged within the tank 440, one or more filters may be arranged within the conduits 436A and 436B and/or valves 434A and 434B.

In some examples, a drain and/or release valve 444 may be incorporated with the filter tank 440 to allow discharge of any remaining fluids following a filter operation. In some examples, the filtering system 430 can be flushed between filter operations, such as with rinse water, which may be released through the drain 444.

The filtering system 430 can operate independently of the system 400, and/or be controlled by a common control system (e.g., the control circuitry 114) to coordinate with operation of other system components. Although illustrated as servicing a single reservoir, in some examples the filtering system 430 can be connected to multiple reservoirs to implement filtering operations on multiple reservoirs simultaneously and/or in turn. In some examples, the filtering system 430 is a contained system and can be attached to and/or removed from a given reservoir.

The foregoing description and accompanying figures illustrate the principles, preferred embodiments, and modes of operation. However, the disclosure should not be construed as being limited to the particular embodiments discussed above. Additional variations of the embodiments discussed above will be appreciated by those skilled in the art.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents. While the controllers and methods are described as being employed in connection with a grinding/polishing and/or hardness/density testing systems, the teachings may be similarly applied to other systems and operations.

All documents cited herein, including journal articles or abstracts, published or corresponding U.S. or foreign patent applications, issued or foreign patents, or any other documents are each entirely incorporated by reference herein, including all data, tables, figures, and text presented in the cited documents.

What is claimed is:

1. An electrochemical machining system for machining a surface of one or more samples, the system comprising:
one or more nozzles configured to dispense one or more jets of one or more electrolyte solutions towards the surface of the one or more samples; and
control circuitry to control an electrochemical machining process, the control circuitry to:
direct the one or more jets of the one or more electrolyte solutions from a first nozzle of the one or more nozzles towards a first portion of the surface of the one or more samples;
direct the one or more jets of the one or more electrolyte solutions from a second nozzle of the one or more nozzles towards a second portion of the surface of the one or more samples; and
apply a charge to the one or more nozzles and apply a charge to the one or more samples such that the nozzles and the samples define first and second electrodes of an electrolytic cell.

2. The system of claim 1, wherein the control circuitry is further configured to control the first nozzle independently of the second nozzle.

3. The system of claim 1, wherein the first nozzle is configured to apply the one or more jets as a first jet of a first electrolyte solution to the one or more samples, and the second nozzle is configured to apply the one or more jets as a second jet of a second electrolyte solution to the one or more samples.

4. The system of claim 3, wherein the first nozzle is configured to apply the first jet of the first electrolyte solution to the first portion of the surface of the sample at a first volumetric rate, a first pressure, or a first speed, and the second nozzle is configured to apply the jet of the second electrolyte solution to the second portion of the surface of the sample at a second volumetric rate, a second pressure, or a second speed.

5. The system of claim 4, wherein the first volumetric rate, the first pressure, or the first speed correspond to a first electrochemical machining program, and wherein the second volumetric rate, the second pressure, or the second speed correspond to a second electrochemical machining program.

6. The system of claim 5, wherein the control circuitry is further configured to:
monitor one or more system parameters; and
adjust one or more of the first or second volumetric rate, the first or second pressure, or the first or second speed, of the first or second electrolyte solution application in response to the one or more system parameters.

7. The system of claim 1, further comprising a first reservoir containing the first electrolyte solution and a second reservoir containing the second electrolyte solution.

8. The system of claim 1, wherein the first and second nozzles operate simultaneously.

9. The system of claim 1, further comprising an interface to receive the input from a user or a code.

10. The system of claim 9, wherein the control circuitry is further configured to automatically select a program or an electrochemical machining program for the one or more samples based on the input or the code.

11. The system of claim 1, further comprising one or more valves configured to receive an external input of airflow to flush the one or more electrolyte solutions from the first or second nozzle.

12. An electrochemical machining system for machining a surface of one or more samples, the system comprising:
one or more reservoirs containing one or more electrolyte solutions one or more nozzles configured to dispense the one or more electrolyte solutions in one or more jets towards the surface of the one or more samples; and
control circuitry to control one or more electrochemical machining processes, the control circuitry to:
direct the one or more jets of the one or more electrolyte solutions from a first reservoir of the one or more reservoirs towards a first portion of a surface of a first sample of the one or more samples; and
direct the one or more jets of the one or more electrolyte solutions from a second reservoir of the one or more reservoirs towards a first portion of a surface of a second sample of the one or more samples; and
apply a charge to the one or more nozzles and apply a charge to the one or more samples such that the nozzles and the samples define first and second electrodes of an electrolytic cell.

13. The system of claim 12, wherein the one or more electrolyte solutions comprises a first electrolyte solution contained in the first reservoir and a second electrolyte solution contained in the second reservoir.

14. The system of claim 12, wherein one of the first or second reservoir includes multiple chambers to hold one or more of a first electrolyte solution, a second electrolyte solution, or other fluids.

15. The system of claim 12, further comprising a water reservoir to recirculate rinse water during the electrochemical machining process.

16. The system of claim 12, further comprising a valve configured to receive an external input of airflow to flush the electrolyte solution from the nozzle.

17. The system of claim 12, further comprising an interface to receive the input from a user or a code.

18. The system of claim 17, wherein the control circuitry is further configured to receive an input providing a size or a processing cycle for the one or more samples.

19. The system of claim 18, wherein the control circuitry is further configured to automatically select a program or an electrochemical machining program for the one or more samples based on the input or the code.

20. The system of claim 19, wherein the control circuitry is further configured to receive selection of a sample type or an electrochemical machining program for the one or more samples and to automatically select the first or second electrolyte based on the selected sample type or electrochemical machining program.
